(19) United States
(12) Patent Application Publication
(10) Pub. No.: US 2018/0097411 A1
(43) Pub. Date: Apr. 5, 2018

(54) WIND ENERGY INSTALLATION AND POLE STACK FOR A SYNCHRONOUS GENERATOR OF A WIND ENERGY INSTALLATION AND SYNCHRONOUS GENERATOR

(71) Applicant: Wobben Properties GmbH, Aurich (DE)

(72) Inventor: Wojciech GIENGIEL, Aurich (DE)

(21) Appl. No.: 15/566,591

(22) PCT Filed: Mar. 11, 2016
(86) PCT No.: PCT/EP2016/055225

§ 371 Date: Oct. 13, 2017

(30) Foreign Application Priority Data
Apr. 13, 2015 (DE) 102015206541.3

(51) Int. Cl. H02K 1/24; H02K 1/08; H02K 15/03

(52) U.S. Cl. CPC H02K 1/24; H02K 1/08; H02K 15/03; H02K 7/1838; H02K 2213/12; H02K 2201/06; H02K 2201/15

(57) ABSTRACT

A synchronous generator and a pole pack for a rotor of a synchronous generator of a wind power plant are disclosed The pole pack has a plurality of pole pack laminations, where each pole pack lamination includes a pole shank region and a pole head region. The pole head region projects laterally beyond the pole shank region and has a side which faces the pole shank region and a side which faces away from the pole shank region. A contour of the pole head region is ellipsoidal at least on the side which faces away from the pole shank region.

### BACKGROUND

### Technical Field

The present invention relates to a wind power plant and, also, to pole packs of a synchronous generator of the wind power plant and, in particular, to the pole pack laminations of the pole packs, and, also, to a synchronous generator of a wind power plant.

### Description of the Related Art

Wind power plants, in particular including gearless wind power plants, are known according to the prior art. Wind power plants are driven by an aerodynamic rotor which is connected directly to the rotor of a generator. The kinetic energy which is obtained from the wind is converted into electrical energy by the movement of the rotor in the generator. The rotor of the generator accordingly rotates at the same slow rotation speed as the aerodynamic rotor.

In order to take into account a slow rotation speed of this kind, the generator has a generator diameter which is relatively large in relation to the nominal power and has a large air gap diameter. The air gap is delimited by pole packs on the rotor side, wherein these pole packs comprise a large number of punched pole pack laminations which are layered one on the other and, for example, are welded to one another to form the pole packs.

According to the prior art, the pole pack laminations of the pole packs have a pole shank region and a pole head region which projects laterally beyond the pole shank region. The pole shank regions of the pole pack laminations of the pole packs, which pole shank regions are arranged one behind the other, are provided with a winding, and an electric field current is supplied to this winding. As a result, magnetic excitation is generated by the pole packs and the corresponding winding together with the field current. This magnetic excitation leads to the pole packs with the winding serving as magnetic poles of the rotor of the synchronous generator.

To this end, it is known to form the pole head region usually such that there is a substantially constant air gap, which is as narrow as possible, between the pole head region and the stator of the synchronous machine, so that the magnitude of the magnetic forces which are generated in the rotor and act on the stator of the generator for producing energy are maximized.

However, generators of this kind have the problem that torque fluctuations are produced by the pole packs which are arranged on the rotor and also the gaps between the pole packs since these result in an unsteady profile of the magnetic field which is generated only by the pole shoes and windings.

These torque fluctuations usually have a frequency which is dependent on the rotation speed of the rotor and cause oscillation in the generator which can also be transmitted to other components of the drive train or of the wind power plant or are superimposed by further oscillations of these components. Oscillations of this kind can lead to damage to the plant and also to an undesired development of noise in the event of continuous operation.

Efforts have already been made to minimize these oscillations, wherein the arrangement and the geometry of the windings have been modified for this purpose. However, to date, these efforts have not led to the desired results.

Therefore, it is desirable to smooth the torque fluctuations of a generator and oscillations which occur as a result and lead to damage to the plant and also to the undesired development of noise, or at least to influence the frequencies of the superimposed oscillations which result from the oscillations, so that undesired frequencies of the oscillations which are contained in the said superimposed oscillations are minimized.

The German patent and trademark office has searched, in the priority application relating to the present application, the following prior art: WO 2012/168238 A2, US 2012/0080973 A1, WO 2012/107109 A1 and DE 10 2013 206 121 A1.

### BRIEF SUMMARY

Disclosed is a pole pack for a synchronous generator of a wind power plant, which pole pack has a plurality of pole pack laminations. Each of the pole pack laminations has a pole shank region and a pole head region. The pole head region projects laterally beyond the pole shank region. Furthermore, the pole head region has a side which faces the pole shank region and a side which is facing away from the pole shank region, wherein the contour of the pole head region is ellipsoidal or has an ellipsoidal profile, that is to say corresponds to or resembles a portion of an elliptical path, at least on that side which faces away from the pole shank region.

An ellipse has a major axis. The major axis corresponds to a straight line which runs through the center point of the ellipse and connects the major vertices or the vertices on the major axis of the ellipse contour or elliptical path which, specifically, correspond to the points of the ellipse contour or elliptical path which are at the greatest distance from one another on the ellipse contour or elliptical path. The major axis is split into the two semi-major axes by the center point.

The minor axis is perpendicular in relation to the major axis and runs through the center point of the ellipse. The minor axis is split into the two semi-minor axes by the center point. Accordingly, the minor axis has the minor vertices or vertices on the minor axis at the point at which the minor axis meets the ellipse contour or elliptical path.

Accordingly, the pole pack laminations, therefore, have, at least at the top side, a contour which is ellipsoidal or in the form of an elliptical path at least between the points of the contour at the widest point of the pole pack lamination. In this case, the top side corresponds to the side of a pole pack lamination which points away from the rotor in the direction of the stator. Therefore, the contour of the pole head region on its top side corresponds to an elliptical path at least between two vertices of an ellipse.

Therefore, the pole pack laminations differ, by virtue of an ellipsoidal rounded portion on their top side, from the known pole pack laminations which have an unsteady gradient or rounded portion, which is matched only to the stator, in the course of the rotation direction of the rotor, in order to achieve as constant an air gap as possible in the region of the pole packs.

The pole packs with a pole head region which is ellipsoidal at least on the top side, that is to say with a pole head region which has an ellipsoidal contour on the top side, leads to a rotor magnetic field which changes continuously over the course of the pole head region. As viewed along the rotation direction of the rotor, there is, therefore, a continuous change in the magnetic field in the region of the pole packs, where the magnetic field drops more severely at the edge regions than in conventional rotors. This results in a smaller difference in the magnetic forces between the pole packs and the gaps which are situated between them, as a result of which, in turn, the torque fluctuations are reduced or smoothed.

The pole pack leads to reduction and/or smoothing of the torque fluctuations in ring generators.

For the configuration of pole packs, it is accepted that an increased field current is required in the rotor - on account of the increase in the size of the air gap - for a comparatively equal torque as when using conventional pole packs.

According to a first embodiment, the contour of the pole head region on that side which faces away from the pole shank region, that is to say the top side, and at least in the edge regions of the pole head region which projects beyond the pole shank region is ellipsoidal.

Accordingly, the contour of the pole head region on that side which is facing away from the pole shank region and additionally a portion, which adjoins the said region of the contour, of the contour of the pole head region which specifically projects beyond the pole shank region and faces the side of the pole head region which faces the pole shank region is likewise ellipsoidal or corresponds to the portion of an elliptical path.

Therefore, according to this embodiment, pole packs of which the pole pack laminations each have a pole head region which has an ellipsoidal contour on the top side and in the edge regions of the respective pole head region are provided.

Owing to a contour of this kind of the pole head region, the magnetic field which is generated by the pole packs and the coils is further influenced in such a way that the torque fluctuations are further smoothed.

According to a further embodiment, the ratio of the semi-major axis of the ellipsoidal contour of the pole head region in relation to the semi-minor axis of the ellipsoidal contour of the pole head region corresponds to a value in the range of from 2 to 8 or 4 to 6.

According to a further advantageous embodiment, the ratio of the semi-major axis of the ellipsoidal contour of the pole head region in relation to the semi-minor axis of the ellipsoidal contour of the pole head region corresponds to a value in the range of from 4.8 to 5.2.

According to a further advantageous embodiment, the ratio of the semi-major axis of the ellipsoidal contour of the pole head region in relation to the semi-minor axis of the ellipsoidal contour of the pole head region corresponds to a value of 5.1, in particular 5.125.

These said ratios of the semi-major axis in relation to the semi-minor axis of the ellipsoidal contour of the pole head region lead to a particularly advantageous minimization of the torque fluctuations since a particularly steady change in the magnetic field is caused in the region of the pole packs owing to this form of the ellipse.

According to a further embodiment, a pole pack has a plurality of pole pack segments, wherein each pole pack segment in each case has one or more pole pack laminations. Each pole shank region of the pole pack laminations further has a first center line and each pole head region of the pole pack laminations has a second center line. According to this embodiment, the distance between the first and the second center line is different at least in two of the pole pack segments which are adjacent to one another.

Torque fluctuations of the generator are further smoothed owing to these pole pack segments of a pole pack which are offset in relation to one another.

According to a further embodiment, the pole pack segments are in the shape of an arrow and/or mirror-symmetrical in plan view. Owing to the arrow-shaped or mirror-symmetrical design, edge regions of adjacent pole packs overlap at least in the edge region of the pole head regions as seen in the horizontal direction. The torque fluctuations are further smoothed as a result.

Furthermore, disclosed is a wind power plant and a synchronous generator for a wind power plant, specifically a wind power plant synchronous generator, having a stator and a rotor, specifically a wind power plant synchronous generator rotor, and a plurality of pole packs, specifically wind power plant synchronous generator rotor pole packs, according to one of the abovementioned embodiments.

According to a further embodiment, the air gap width or width between the stator and the rotor is not constant and, therefore, changes continuously or steadily in the region of the pole packs as seen in the circumferential direction.

A synchronous generator of this kind has a particularly advantageous behavior in relation to torque fluctuations by advantageously smoothing the torque fluctuations.

### BRIEF DESCRIPTION OF THE SEVERAL VIEWS OF THE DRAWINGS

Exemplary embodiments of the invention will be explained in greater detail below with reference to the drawing.

FIG. 1 shows a wind power plant,

FIG. 2 shows a schematic sectional view through a pole pack according to a first exemplary embodiment,

FIG. 3 shows a plan view of a pole pack according to an exemplary embodiment, and

FIG. 4 shows a lateral view of a pole pack according to an exemplary embodiment.

### DETAILED DESCRIPTION

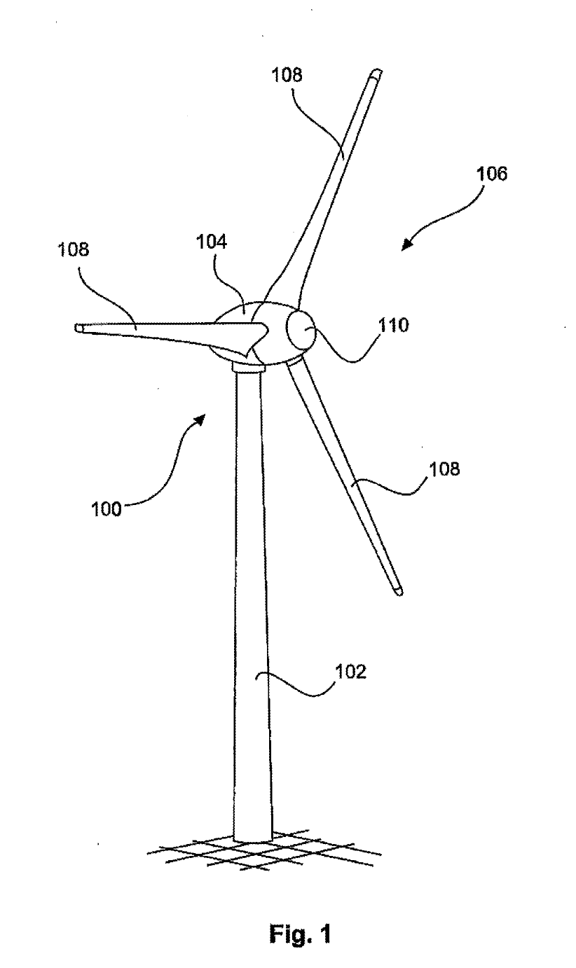

FIG. 1 shows a schematic illustration of a wind power plant. The wind power plant 100 has a tower 102 and a nacelle 104 on the tower 102. An aerodynamic rotor 106 with three rotor blades 108 and a spinner 110 is provided on the nacelle 104. During operation of the wind power plant, the aerodynamic rotor 106 is made to rotate by the wind, and, therefore, a rotor of a generator, in particular of a synchronous generator, which is directly or indirectly coupled to the aerodynamic rotor 106 also rotates. The electric generator is arranged in the nacelle 104 and generates electrical energy. The pitch angle of the rotor blades 108 can be changed by pitch motors at the rotor blade roots 108b of the respective rotor blades 108.

The pole packs described below are used for a rotor of a synchronous generator or a rotor of a ring generator.

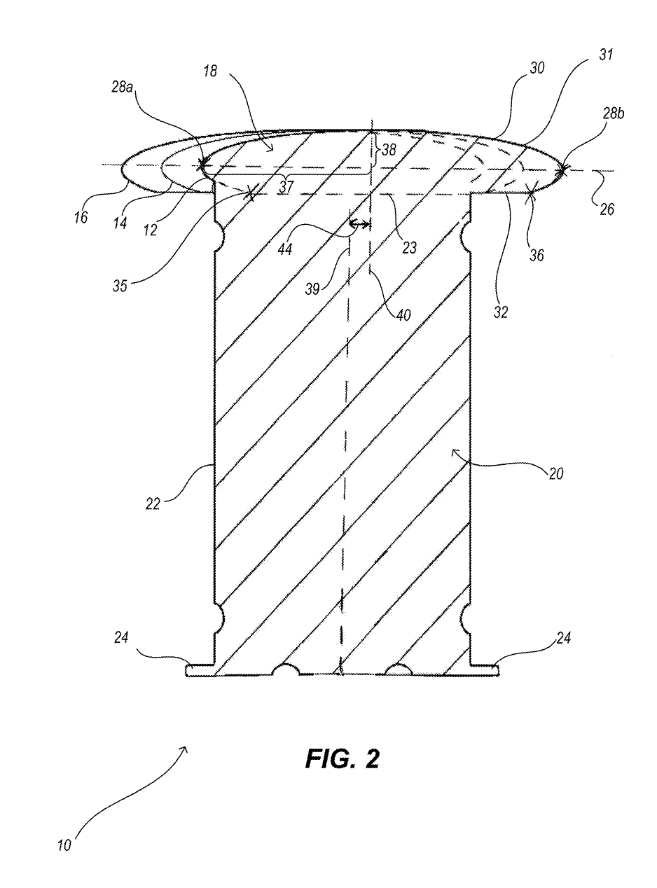

FIG. 2 shows a schematic sectional view through a pole pack of a rotor of a synchronous generator according to a first exemplary embodiment. The pole pack 10 has a number of pole pack segments 12, 14, 16. Each pole pack segment 12, 14, 16 has a pole pack lamination 22 or a plurality of identical pole pack laminations 22. Each pole pack lamination 22 has a pole head region 18 and a pole shank region 20.

In FIG. 2, the pole head region 18 and the pole shank region 20 are illustrated such that they are separated by a separating line 23, wherein this separating line 23 does not represent a seam in the pole pack lamination 22, but rather is illustrated to ease understanding. The pole pack laminations 22 are, accordingly, preferably each integrally formed and, in particular, punched out for production purposes. The pole shank region 20 is substantially rectangular and optionally has two lugs 24 in the lower region.

The pole head region 18 is subdivided into an upper part 30 and a lower part 32 along the dashed line 26 which runs through the vertices 28a, 28b of the first pole pack segment 12. In this case, the upper part 30 of the pole head region 18 corresponds to a side 30, which faces away from the pole shank region 20, and has an ellipsoidal contour 31, wherein the lower part 32, which corresponds to a side 32 which faces the pole shank region 20, also at least partially has an ellipsoidal contour 31. The pole head region 18 extends laterally beyond the pole shank region 20.

Accordingly, the contour 31 of the pole head region 18 on that side 30 which is away from the pole shank region 20, specifically the upper side 30 of the pole head region 18, is ellipsoidal. Furthermore, an adjoining portion of the contour 31 of the pole head region 18, which projects beyond the pole shank region 20, and on the side 32 of the pole head region 18 which faces the pole shank region 20 and, therefore, corresponds to the lower part 32 of the pole head region 18 is also ellipsoidal.

For the illustrated first pole pack segment 12, the pole head region 18, accordingly, has an ellipsoidal form from the point 35 to the point 36 along the contour 31 of the pole head region 18 as seen in the clockwise direction.

The ratio of the semi-major axis 37 in relation to the semi-minor axis 38 of the contour of the pole head region, which contour is in the form of an elliptical path, corresponds to a value in the range of from 4 to 6.

Each of the pole pack segments 12, 14, 16 has a pole pack lamination 22 or a plurality of identical pole pack laminations 22, wherein the pole pack shanks 20 of the pole pack segments 12, 14, 16 have a common center line 39, while the pole pack regions 18 of the pole packs 12, 14, 16 each have a center line 40 which runs parallel to the center line 39 of the pole shank region 20 and in each case runs through the center point of the ellipse which is formed by the pole head region. This center line 40 of the pole head regions 18 of adjacent pole pack segments 12, 14, 16 are at different distances from the center line 39 of the pole shank region.

Accordingly, the pole head regions 18 of adjacent pole pack segments 12, 14, 16 are offset in relation to one another. Accordingly, the positions of the pole shank regions 20 of a pole pack segment 12, 14, 16 relative to the respective pole head regions 18 in adjacent pole pack segments 12, 14, 16 are different.

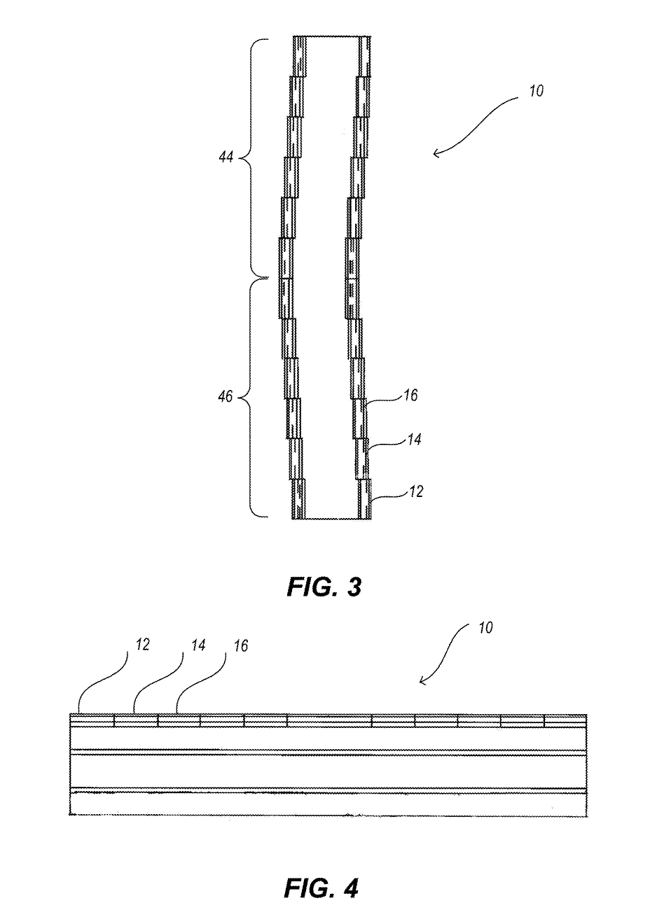

FIG. 3 shows a schematic plan view of a pole pack 10 with a plurality of pole pack segments 12, 14, 16, wherein the pole packs 10 in the upper region 44 are arranged in a mirror-symmetrical manner in relation to the pole packs 10 in the lower region 46. The entire pole pack 10 has an arrow-shaped arrangement.

FIG. 4 shows a side view of the pole pack 10. The pole packs 10 are each provided with a winding and this winding is supplied with an electric current, so that the pole packs 10 and the corresponding winding together with a field current generate magnetic excitation. This magnetic excitation leads to the pole pack 10 with the winding serving as a magnetic pole. Accordingly, the pole of an electrical machine with a pole pack 10, a winding and a field current is formed.

According to one embodiment, the pole pack laminations 22 are produced using separation methods, wherein the separation involves a punching-out operation, a lasering operation, a water-jet cutting operation or a cutting-out operation. The pole pack 10 serves to generate excitation fields on a rotor of a synchronous generator, in particular of an externally excited synchronous generator.

The synchronous generator of the wind power plant, that is to say of the wind power plant synchronous generator, is preferably a ring generator or a synchronous ring generator. A multi-pole synchronous ring generator of this kind of a gearless wind power plant has a large number of stator poles, in particular at least 48 stator teeth, frequently even considerably more stator teeth, such as, in particular, 96 stator teeth or even more stator teeth.

The magnetically active region of the ring generator, specifically both of the rotor and of the stator, is arranged in an annular region around the rotation axis of the synchronous generator. Therefore, in particular, a region of from 0 to at least 50 percent of the radius of the air gap is free of materials which carry electric current or electric field of the synchronous generator. In particular, this interior space is completely free and, in principle, also accessible. This region is often also more than 0 to 50 percent of the air gap radius, in particular up to 0 to 70 percent or even 0 to 80 percent of the air gap radius. Depending on the design, there may be a carrying structure in this inner region, but the carrying structure can be axially offset in some embodiments.

The pole packs are used in a synchronous generator rotor or in a ring generator rotor. Both the synchronous generator and the ring generator represent a slowly rotating synchronous generator with a rotation speed of less than 30, 25 or even 20 revolutions per minute.

The diameter of the synchronous generator rotor or of the ring generator rotor is typically several meters, wherein the air gap diameter is at least 3 or even more than 5 meters. The synchronous generator or the ring generator has a power of at least 100 kilowatts, at least 500 kilowatts, or preferably at least 1 megawatt (MW), but can also be 3 MW or up to 10 MW.

1. A wind power plant comprising:
a synchronous generator that has a power of at least 500 kilowatts and an air gap diameter of at least three meters, the synchronous generator including:
a stator; and
a rotor having a plurality of pole packs,
wherein:
each pole pack of the plurality of pole packs has a plurality of pole pack laminations and each pole pack lamination of the plurality of pole pack laminations includes a pole shank region and a pole head region,
the pole head region projects laterally beyond the pole shank region, and the pole head region has a side facing the pole shank region and a side facing away from the pole shank region, and
a contour of the pole head region is ellipsoidal or has a semi-elliptical path at least on the side facing away from the pole shank region.

2. The wind power plant according to claim 1, wherein the contour of the pole head region on the side facing away from the pole shank region is ellipsoidal or has a semi-elliptical path, and wherein at least an adjoining portion of a contour of the pole head region projecting beyond the pole shank region and facing the side which faces the pole shank region is ellipsoidal or has a semi-elliptical path.

3. The wind power plant according to claim 1, wherein a ratio of a semi-major axis in relation to a semi-minor axis of an ellipse defined by the contour of the pole head region has a value ranging from 4 to 6.

4. The wind power plant according to claim 3, wherein the ratio of the semi-major axis in relation to the semi-minor axis of the ellipse defined by the contour of the pole head region has a value ranging from 4.8 to 5.2.

5. The wind power plant according to claim 1, wherein:
the pole pack of the plurality of pole packs includes a plurality of pole pack segments and each pole pack segment includes one or more pole pack laminations of the plurality of pole pack laminations,
each pole shank region of the pole pack laminations has a first center line and each pole head region has a second center line, and
a distance between the first center line and the second center line is different in at least two adjacent pole pack segments.

6. The wind power plant according to claim 5, wherein an arrangement of the pole pack segments is at least one of: in a shape of an arrow and is mirror-symmetrical in plane view.

7. The wind power plant according to claim 1, wherein an air gap between the stator and the rotor has a non-constant width in a circumferential direction in the region of the pole packs.

8. A pole pack for a rotor of a synchronous generator of a wind power plant, comprising:
a plurality of pole pack laminations, each pole pack lamination of the plurality of pole pack laminations includes:
a pole shank region; and
a pole head region, wherein:
the pole head region projects laterally beyond the pole shank region, and the pole head region has a side which faces the pole shank region and a side facing away from the pole shank region, and wherein
the contour of the pole head region is at least one of: ellipsoidal or has an elliptical path at least on the side facing away from the pole shank region.

9. A synchronous generator for a wind power plant, having a stator and a rotor with a plurality of pole packs according to claim 8.

10. The wind power plant according to claim 1, wherein the synchronous generator is a ring generator.

11. The wind power plant according to claim 4, wherein the ratio of the semi-major axis in relation to the semi-minor axis of the ellipse defined by the contour of the pole head region has a value of 5.1.

12. The synchronous generator according to claim 9, wherein an air gap between the stator and the rotor has a non-constant width in the circumferential direction in a region of pole packs.
